(19) United States
(12) Patent Application Publication
(10) Pub. No.: US 2024/0419988 A1
(43) Pub. Date: Dec. 19, 2024

(54) VALIDATING ANSWERS FROM AN ARTIFICIAL INTELLIGENCE CHATBOT

(71) Applicant: INTERNATIONAL BUSINESS MACHINES CORPORATION, Armonk, NY (US)

(72) Inventors: Jun Su, Beijing (CN); YANG LIANG, Beijing (CN); Su Liu, Austin, TX (US); James Nash, Lewisville, TX (US)

(21) Appl. No.: 18/335,855

(22) Filed: Jun. 15, 2023

(51) Int. Cl. G06N 5/04

(52) U.S. Cl. CPC G06N 5/04

(57) ABSTRACT

Provided are a computer program product, system, and method for validating answers from an artificial intelligence chatbot. An answer is received to a question submitted to the artificial intelligence chatbot. A database is searched using keywords from the answer to obtain a reference for the answer. A similarity score is calculated between the answer and the reference. A determination is made as to whether the similarity score exceeds a threshold value. Answer information indicates that the answer is valid in response to the similarity score exceeding the threshold value or that the answer is invalid in response to the similarity score not exceeding the threshold value. An answer report indicating whether the answer is valid or invalid to transmit to a user a user that submitted the question to render.

### BACKGROUND OF THE INVENTION

### 1. Field of the Invention

The present invention relates to a computer program product, system, and method for validating answers from an artificial intelligence chatbot.

### 2. Description of the Related Art

An artificial intelligence (“AI”) chatbot returns one or more answers to a question submitted by a user. The AI chatbot can generate answers based on a vast database of information which may be preprocessed and stored. The AI chatbot may use machine learning algorithms to understand user questions and provide accurate and helpful responses, such as deep learning techniques to generate responses to natural language queries. AI chatbots have demonstrated impressive capabilities in tasks such as language translation, question answering, and text completion.

### SUMMARY

Provided are a computer program product, system, and method for validating answers from an artificial intelligence chatbot. An answer is received to a question submitted to the artificial intelligence chatbot. A database is searched using keywords from the answer to obtain a reference for the answer. A similarity score is calculated between the answer and the reference. A determination is made as to whether the similarity score exceeds a threshold value. Answer information indicates that the answer is valid in response to the similarity score exceeding the threshold value or that the answer is invalid in response to the similarity score not exceeding the threshold value. An answer report indicating whether the answer is valid or invalid to transmit to a user a user that submitted the question to render.

### BRIEF DESCRIPTION OF THE DRAWINGS

FIG. 1 illustrates a computing environment to validate answers from a chatbot.

FIG. 2 illustrates an embodiment of an answer data structure.

FIG. 3 illustrates an example of content in an answer data structure.

FIG. 4 illustrates an embodiment of information in an answer report providing validation information on answers from a chatbot.

FIG. 5 illustrates an embodiment of operations performed in a client computer to send a question to a chatbot server and initiate validation of the answers.

FIG. 6 illustrates an embodiment of operations to perform validation of answers to a question provided by a chatbot.

FIG. 7 illustrates an embodiment of operations to calculate a similarity score between an answer and a located reference.

FIG. 8 illustrates an embodiment of operations performed at a client computer to render information on answers from an answer report including graphical indication of whether the answers are valid or invalid.

FIG. 9 depicts a computing environment in which the components of FIG. 1 may be implemented.

### DETAILED DESCRIPTION

The description herein provides examples of embodiments of the invention, and variations and substitutions may be made in other embodiments. Several examples will now be provided to further clarify various embodiments of the present disclosure:

Example 1: A computer-implemented method for verifying answers produced from an artificial intelligence chatbot in response to questions inputted to the artificial intelligence chatbot. The method comprises receiving an answer to a question submitted to the artificial intelligence chatbot. The method further comprises searching a database using keywords from the answer to obtain a reference for the answer. The method further comprises calculating a similarity score between the answer and the reference. The method further comprises determining whether the similarity score exceeds a threshold value. The method further comprises indicating, in answer information, that the answer is valid in response to the similarity score exceeding the threshold value or that the answer is invalid in response to the similarity score not exceeding the threshold value. The method further comprises generating an answer report indicating whether the answer is valid or invalid to transmit to a user a user that submitted the question to render. Thus, embodiments advantageously allow answers from the chatbot to be analyzed in real-time to locate external references for the chatbot answers in real-time. In addition, embodiments advantageously allow the chatbot answers to be validated from the located references. Yet further, embodiments advantageously allow information on the answers and the references used to validate the answers to be presented to the user and the correspondence of answers to located references and indication of whether the answers are valid or invalid in view of the corresponding located references.

Example 2: The limitations of any of Examples 1 and 3-8, where the method for calculating the similarity score between the answer and the reference further comprises determining word type similarity scores between words in the answer, of at least one specified word type, to words in the reference. The method further comprises aggregating the word type similarity scores to produce the similarity score between the answer and the reference. Thus, embodiments advantageously improve calculation of the similarity score between the answer and the reference by comparing words of a specified word type that are more predictive of similarity than other words.

Example 3: The limitations of any of Examples 1, 2, and 4-8, where the method further comprises determining a domain of the question. The method further comprises determining specified word types for the domain, where the at least one specified word type comprises the determined specified word types for the domain. Thus, embodiments advantageously improve accuracy of the calculation of the similarity score between the answer and the reference by comparing words of a specified word type for a particular domain that are more predictive of similarity in the answers than word types in other domains.

Example 4: The limitations of any of Examples 1-3 and 5-8, where the method further comprises that the specified word type is part of plurality of specified word types, where there is a weight for each of the specified word types. The method further comprises that the calculating the word type similarity scores comprises for each word type of the word types, calculating a weighted average similarity score as an average of the similarity scores for the word type multiplied by a weight for the word type. The method further comprises summing weighted average similarity scores for the word types to produce the similarity score between the answer and the reference. Thus, embodiments advantageously improve the accuracy of the similarity score calculation by weighting similarity scores for word types by specific weights provided for a word type and then summing the weighted average of the similarity scores. This allows for word types having greater predictiveness of similarity more in the similarity score calculation than word types less predictive of similarity.

Example 5: The limitations of any of Examples 1-4 and 6-8, where the method further comprises receiving a plurality of answers to the question. The method further comprises that the operations of searching the database, determining the similarity score, and determining whether the similarity score exceeds the threshold value are performed for the answers, where the answer report renders information indicating whether the answers are valid or invalid. Thus, embodiments advantageously improve the accuracy of the similarity score and validity determination when there are multiple answers to a question by determining a similarity score for each of the plurality of answers to the question so that the validity of all the answers to a question are rendered in the answer report.

Example 6: The limitations of any of Examples 1-5 and 7-8, where the method further comprises updating the answer information to indicate the reference and information to locate the reference. The method further comprises providing the answer information to use to train the artificial intelligence chatbot to produce an invalid answer with a low confidence level. Thus, embodiments advantageously allow the chatbot to be trained to produce answers determined to be invalid according to the reference with a low confidence level to improve the accuracy of answers and reduce producing answers that are likely invalid.

Example 7: The limitations of any of Examples 1-6 and 8, where the method further comprises that the answer report juxtaposes the answer with respect to content of the reference and visual indication of whether the answer is valid or invalid. Thus, embodiments advantageously juxtapose the answer with content of the reference to allow the user receiving the answer to visualize how the answer is incorrect with respect to the located reference.

Example 8: The limitations of any of Examples 1-7, where the method further comprises determining a domain of the question and the answer. The method further comprises determining a domain database applicable to the domain of the question and the answer, where the domain database is searched to obtain the reference. Thus, embodiments advantageously determine a domain of the question so that databases specific to the domain of the question are searched for answers to the question to improve accuracy of the returned answer.

Additionally or alternatively, an embodiment in which the element of Example 1 of calculating a similarity score between the answer and the reference comprises determining word type similarity scores between words in the answer, of at least one specified word type, to words in the reference and aggregating the word type similarity scores to produce the similarity score between the answer and the reference, has the technical effect of improving the calculation of the similarity score by determining word type similarity scores between words in the answer of a specified word type to words in the reference by considering those specified word types having a greater predictive quality for determining the similarity score.

Users may receive answers to questions from an AI chatbot and be concerned that the answers they have received are valid and accurate. AI chatbots responses can be opaque, which makes it difficult for users to determine the sources of the information provided. This lack of transparency can decrease user trust in AI chatbot responses and may lead to errors or inaccuracies in the information provided. Further, AI chatbot responses may not provide all of the information necessary to fully answer a question or provide a comprehensive understanding of a topic. Without additional sources of information, users may be left with an incomplete understanding of the subject matter. Further, users may want to verify the accuracy of the answers, and without cited source information, users may have difficulty verifying the accuracy of an AI chatbot answers. This can be especially problematic in situations where the information provided is important or sensitive, such as in educational or legal contexts.

Further, current AI chatbots may not provide users with the ability to customize the level of detail or type of sources presented in its responses. This can be problematic for users who have specific needs or preferences for the types of sources they require. Further, users may want validation of AI chatbot answers in real-time.

Described embodiments provide improvements to computer technology for validating answers from a chatbot. With described embodiments, answers from the chatbot may be analyzed in real-time to locate external references for the chatbot answers in real-time. The chatbot answers may then be validated in real-time from the located references. This information on the answers and the references used to validate the answers may be rendered in a computer user interface of a user to graphically present the correspondence of answers to located references and indication of whether the answers are valid or invalid in view of the corresponding located references.

Further, the information from the validation, including information on the question, answer, located reference, and indication of validity/invalidity, may be sent to the AI chatbot to retrain the AI chatbot, implementing a machine learning model, to produce more accurate results. The AI chatbot may be trained to produce answers to questions that are derived from the located references that were used to invalidate the previous chatbot answers.

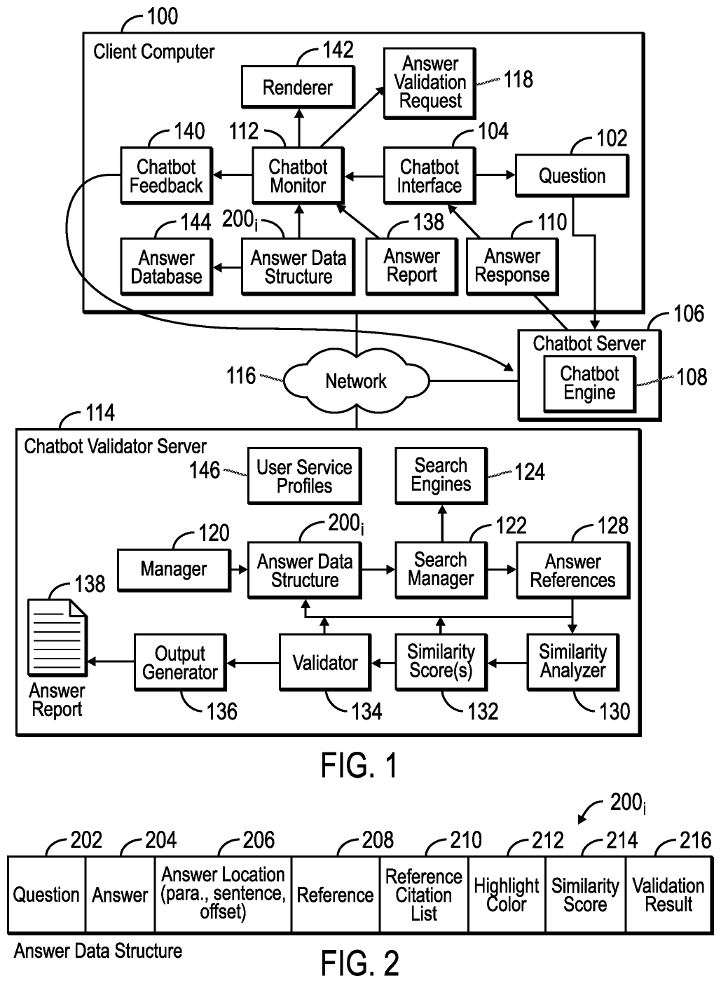

FIG. 1 illustrates an embodiment of a network computing environment having a client computer 100 that sends questions 102 via a chatbot interface 104 to a chatbot server 106, such as an artificial intelligence chatbot. The chatbot server 106 includes a chatbot engine 108 to generate an answer response 110 including one or more answers to the question 102 and returns to the client 100. A chatbot monitor 112 receives the answer response 110 from the chatbot server 106, which may include one or more answers to the question 102. The chatbot monitor 112 may generate an answer validation request 118 including the question 102, the answer response 110 with one or more answers, and a request to validate the answers in the answer response 110 for the question 102. The chatbot monitor 112 forwards the answer validation request 118 to the chatbot validator server 114 to validate the answers in the answer response 110 with respect to the question 102. The client 100, chatbot server 106, and chatbot validator server 114 may communicate over a network 116.

Examples of chatbot engines 108 include chatbots based on the GPT-3.5 architecture, such as ChatGPT developed by OpenAIR, IBM Watson Assistant®, Microsoft Bot Framework®, Amazon Lex®, etc. (OpenAI is a registered trademark throughout the world of Open AI LP; IBM Watson Assistant is a registered trademark throughout the world of International Business Machines Corporation, Inc.; Microsoft Bot Framework is a registered trademark throughout the world of Microsoft Corporation; and Amazon Lex is a registered trademark throughout the world of Amazon Technologies, Inc.)

The chatbot validator server 114 includes a manager 120 to receive the answer validation request 118 from the client 100 and generate one or more answer data structures 200, one for each answer i in the answer response 110, including information on the question 102 and the answers in the answer response 110. The question 102 and answer(s) in the answer response 110 are provided to the search manager 122 to select one or more search engines 124 to use to search for keywords in the answer(s). The search manager 122 may use natural language processing (NLP) to determine keywords in the answer response 110 to include in a search for answer references 126, such as articles, patents, publications, etc., that contain information that could validate or invalidate the answers in the answer response 110.

The search manager 122 may select one or more of the search engines 124 to use based on a domain of the question 102, where different search engines 124 are associated with different domains. The search engines 124 may search Internet web sites, local network locations, and other public and private databases for answer references 126.

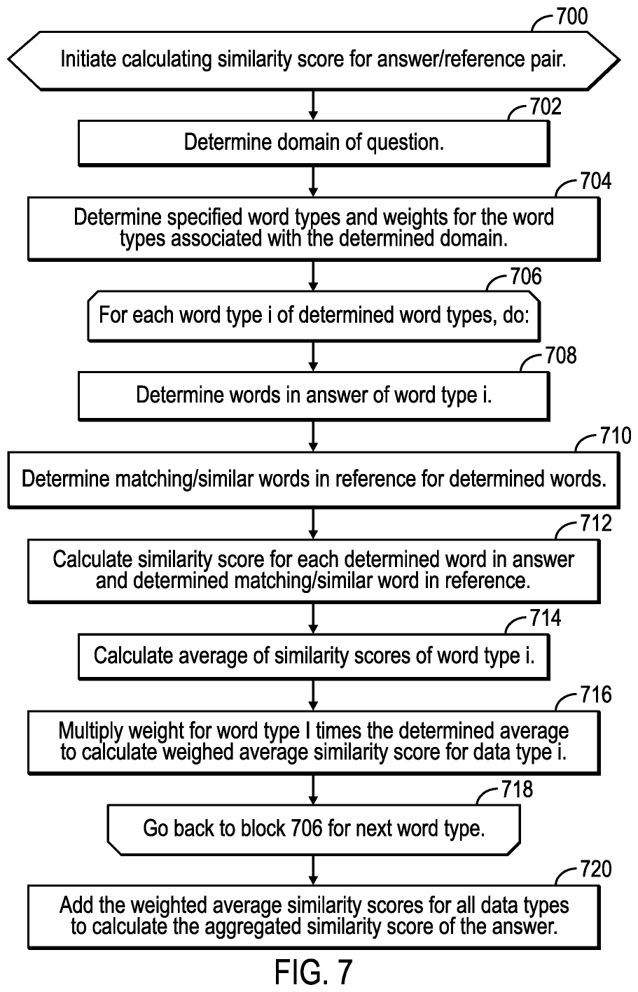

The answer references 128 and answers in the answer response 110 are provided to a similarity analyzer 130 which determines a similarity score 132 of the content of an answer with content of a reference 128 the search engine 124 located for the answer keywords. The similarity score 132 may be determined using a comparison algorithm used to determine similarity of content, such as algorithms that represents different text content as vectors and then determine similarity of the text content based on the vector representations, such as using cosine similarity, Word2Vec, Doc2 Vect, FastText, etc. Other techniques may be used to compare similarity, such as the technique described with respect to FIG. 7 that compares certain word types in the answer 110 to text in the reference 128 to determine a similarity score of the reference 128 to an answer.

A validator 134 determines whether the similarity score 132 for an answer and reference 128 satisfy a threshold, e.g., greater than some number such as 80%, which indicates a level of trust of the answer. The answer data structure 200ᵢ for an answer i in the answer response 110 may be updated to include information on the answer reference 128, the similarity score 132, and whether the answer i in the answer response 110 is valid or invalid based on a degree of similarity to the reference 128. In this way, if there is a reference 128 to support the answer response 110 content, which is sufficiently similar, then the answer is validated. The information on the answers and references 128 and the validation result 216 are provided to an output generator 136 which generates an answer report 138 coded in a markup language, such as Hypertext Markup Language (HTML), Extended Markup Language (XML), etc., to juxtapose content from the references 128 with the answers and indicate whether the answers in the answer report 138 are valid or invalid based on the references 128.

This answer report 138 and the answer data structure(s) 200ᵢ for the answer(s) in the answer response 110 are returned to the client computer 100 over the network 116. Upon receiving the answer report 138 and answer data structure(s) 200ᵢ, the chatbot monitor 112 may add the received answer data structure(s) 200ᵢ to the answer database 144. The chatbot monitor 112 forwards the answer report 138 to the renderer 142 to render the answer report 138 for the user to view on a computer display or make accessible via other means, such as audio. For answer(s) in the answer response 110 that are not validated, the chatbot monitor 112 may generate chatbot feedback 140 indicating an answer that is not validated and the reference 128 having the information that resulted in the invalid determination. The chatbot server 106 may use the chatbot feedback 140 to retrain the chatbot engine 108 to produce an answer derived from the reference 128, where the answer may be generated by an NLP engine, with a high confidence level. For instance, if the chatbot engine 108 utilizes a machine learning model, then the chatbot engine 108 may be retrained using backpropagation techniques to produce an answer derived from the reference 128 with input comprising the question 102, or an NLP representation of the question 102.

The chatbot validator server 114 may maintain user service profiles 146 that include information for different users of the chatbot validator server 114, such as thresholds used to validate the similarity scores 132 and word types and weights for word types to use in the similarity comparison, as described with respect to FIG. 7.

Generally, program modules, such as the program components 104, 106, 108, 112, 120, 122, 124, 130, 134, 136, 142 among others, may comprise routines, programs, objects, components, logic, data structures, and so on that perform particular tasks or implement particular abstract data types.

The programs 104, 106, 108, 112, 120, 122, 124, 130, 134, 136, 142, among others, may comprise program code loaded into memory and executed by a processor. Alternatively, some or all of the functions of these components may be implemented in hardware devices, such as in Application Specific Integrated Circuits (ASICs) or executed by separate dedicated processors.

The functions described as performed by the program components 104, 106, 108, 112, 120, 122, 124, 130, 134, 136, 142, among others, may be implemented as program code in fewer program modules than shown or implemented as program code throughout a greater number of program modules than shown.

The client computer 100 may comprise a personal computing device, such as a laptop, desktop computer, tablet, smartphone, wearable computer, mixed reality display, virtual reality display, augmented reality display, etc. The chatbot validator server 114 and chatbot server 106 may comprise one or more server class computing devices, or other suitable computing devices.

In FIG. 1, arrows are shown between components in the user client computer 100 and chatbot validator server 114. These arrows represent information flow to and from the program components.

The network 116 may comprise a Storage Area Network (SAN), Local Area Network (LAN), Intranet, the Internet, Wide Area Network (WAN), peer-to-peer network, wireless network, arbitrated loop network, etc.

FIG. 2 illustrates an embodiment of an answer data structure 200ᵢ generated for one of the answers included in an answer response 110 and comprises: a question 202, such as question 102 provided with the answer validation request 118; an answer 204 comprising one of the answers i included in the answer validation request 118 and may identify the answer response 110; the answer 204 location in the answer response 110, such as paragraph, sentence, and offset in the sentence; a reference 208 located by the search engine 124 for the answer 204, such as reference 128; a reference citation list 210 having bibliographical information on the reference 208, such as author, date of publication, title, publisher, and electronic location, e.g., Uniform Resource Locator (URL), global identifier, etc.; a highlight color 212 to use to highlight the references 128 returned for the answer 204, which may be specified in user service profiles 146 for the user of the client computer 100 that generated the answer validation request 118; the similarity score 214 between the answer 204 and the reference 208, which may be considered a trust score indicating an extent to which the answer 204 can be trusted; and a validation result 216 indicating whether the similarity score 214 indicates the answer 204 is valid or invalid.

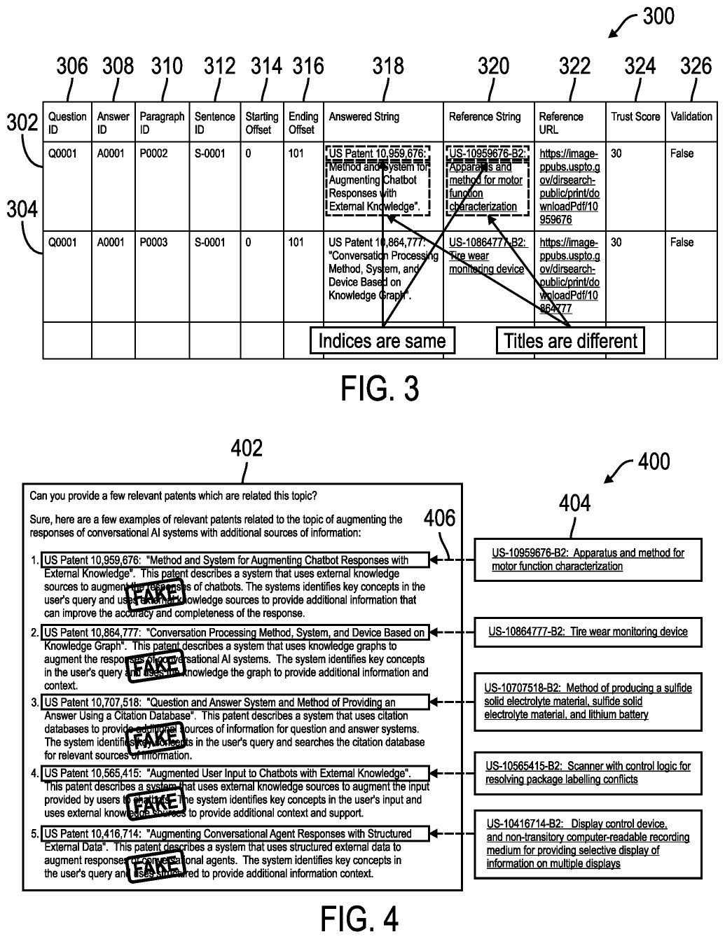

FIG. 3 illustrates an example of a table 300 implementing answer data structures 200ᵢ in rows 302, 304, including: a question ID column 306 corresponding to the question field 202; an answer ID column 308 corresponding to the answer field 204 and identifies the answer report having the answers; a paragraph ID column 310, a sentence ID column 312, starting 314 and ending 316 offset columns corresponding to the answer location 206 field that identifies the paragraphs and locations in the paragraphs in which the different answers are maintained; answered string column 318 providing answer content corresponding to answer field 204; a reference string column 320 providing reference content corresponding to reference column 208; a reference URL column 322 corresponding to the reference citation list 210 field; a trust score column 324 corresponding to the similarity score field 214; and a validation column 326 corresponding to validation result 216.

FIG. 3 shows how the answers 302, 304 are not validated because the titles in the answer 318 differ from the titles in the reference string 320 even though the indices or patent numbers in the answer and reference are the same. This difference results in a low trust score 30%, i.e., similarity score, and a validation 326 result of false or invalid.

FIG. 4 provides an example of the answer report 400 showing the answers 402 with content highlighted to correspond to content from the references 404 for the answers. The answers 402 are shown with an indicator of “FAKE” because the highlighted titles of the answers 402 do not match the titles in the corresponding references 404, where correspondence is shown by the dashed lines connecting an answer to a reference, e.g., 406. corresponding to the answers. In FIG. 4, the references may comprises patent numbers and their titles from a patent database searched using an engine for searching a verified patent database. Although the patent numbers in the answers 402 and references 404 match, the titles do not resulting in the answers not being validated and indicated as “FAKE” in the answer report 400.

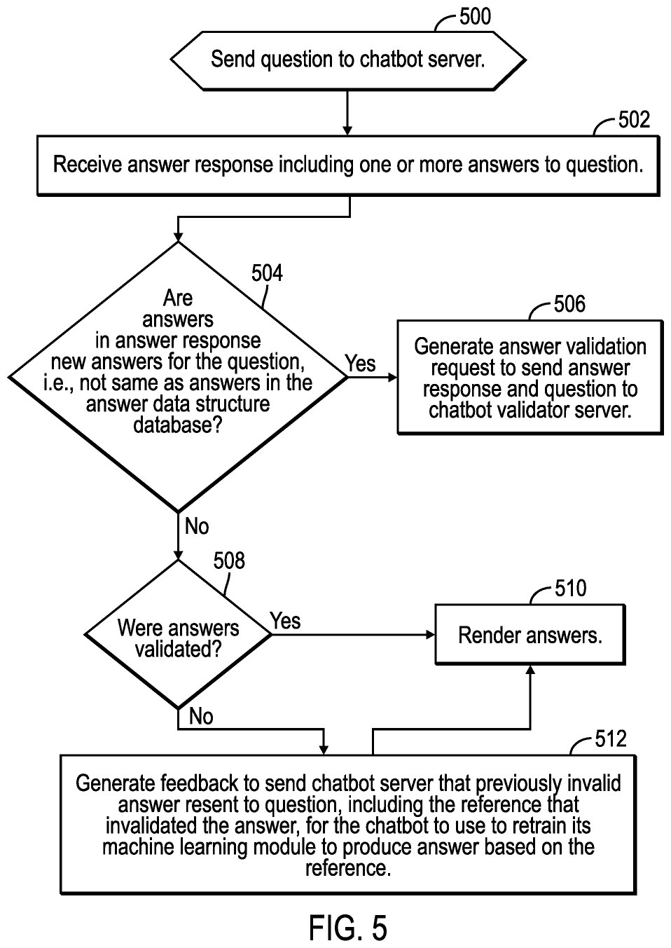

FIG. 5 illustrates an embodiment of operations performed by the client machine 100, such as by the chatbot interface 104 and chatbot monitor 112, to process a question 102 received from a user of the client machine 100. Upon receiving the question 102, the chatbot interface 104 sends (at block 500) the question to the chatbot server 106. The chatbot interface 104 receives (at block 502) an answer response 110 having one or more answers generated by the chatbot engine 108 to the question 102. If (at block 504) the answers in the answer response 110 are new answers for the question 102, i.e., not same as answers in the answer database 144, then the chatbot monitor 112 generates (at block 506) an answer validation request 118, including the answer response 110 and question 102, and sends to the chatbot validator server 114. If (at block 504) the received answers in the answer response 110 match those in the answer database 144 and if (at block 508) the answers are indicated as valid in the saved answer data structure 200ᵢ for the received answers, then the received answers are rendered (at block 510) by the renderer 142. If (at block 506) the answers were previously determined to be invalid according to the answer data structure 200ᵢ having the same answers, then the chatbot monitor 112 generates (at block 512) chatbot feedback 140 to send to the chatbot server 106 that indicates that the chatbot server 106 sent an answer that was previously determined to be invalid in response to the question 102. The chatbot feedback 140 includes the reference(s) 208 that invalidated the answer(s) in the answer response 110 to use to retrain the chatbot engine 108 machine learning module to produce an answer for the question 102 based on the reference 208. The false answers not validated are also rendered (at block 510), as shown in FIG. 4.

With the embodiment of FIG. 5, the client machine 100 may determine if the chatbot server 106 provides an answer that was previously determined to be invalid and then send feedback 140 to the chatbot server 106 to retrain the chatbot engine 108 to stop sending the invalid answers. Further, if there is a new answer, the client machine 100 may forward an answer validation request 118 to the chatbot validator server 114 to validate the new answer, not stored in the answer database 144, from the chatbot engine 108 with references 128.

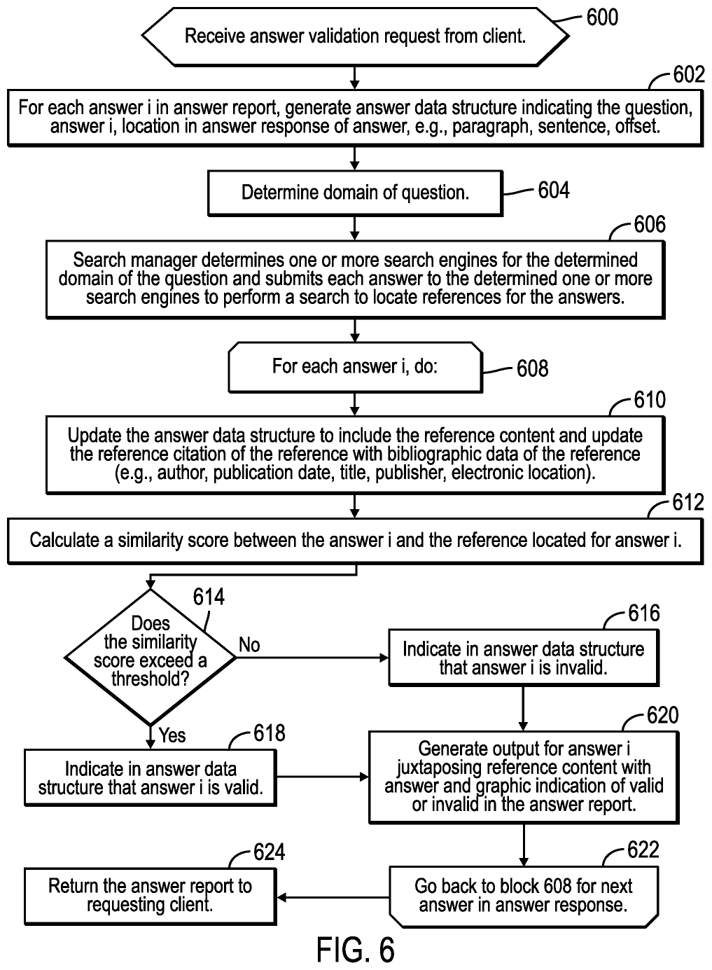

FIG. 6 illustrates an embodiment of operations performed by the chatbot validator server 114, including the manager 120, the search manager 122, search engine 124, similarity analyzer 130, validator 134, and output generator 136, to determine whether answers in an answer response 110 returned by the chatbot engine 108 to a question 102 are valid based on located references 128 having keywords matching the keywords of the answers from the chatbot engine 108. Upon receiving (at block 600) the answer validation request 118 from the client 100, the manager 120 generates (at block 602), for each answer i in the answer response 110, an answer data structure 200ᵢ indicating the question 202, answer i 204, location 206 in answer response 110 of answer i, e.g., paragraph, sentence, offset. The search manager 122 may then determine (at block 604) a domain of the question 102, such as a topic, category, etc., such as by using natural language processing (NLP). The search manager 122 determines (at block 606) one or more search engines 124 for the determined domain of the question and submits each answer to the determined one or more search engines 124 to find references 128 for the answers. If the search engine 124 finds multiple search results for the searched keywords from the answer, then the search engine 124 may return the most applicable or relevant search result according to a relevance metric.

A loop of operations is performed at blocks 608 through 622 for each answer i in the answer response 110. At block 610, the manager 120 updates the answer data structure 200ᵢ for answer i to include the reference content 208 located from the search engine 124 and a reference citation list 210 is updated with bibliographic data on the reference (e.g., author, publication date, title, publisher, electronic location). The similarity analyzer 130 calculates (at block 612) a similarity score 132 between the answer i and the reference 128 located for answer i. The validator 134 determines (at block 614) whether the similarity score 132 exceeds a threshold, which may be provided by the user service profile 146 for the user that sent the answer validation request 118. If (at block 614) the similarity score does not exceed the threshold, then validator 134 updates (at block 616) validation result 216 to indicate invalid or “fake”. If (at block 614) the threshold is exceeded, then the validator 134 indicates (at block 618) in the validation result 216 for answer data structure 200ᵢ that answer i is valid. The output generator 136 generates (at block 620) output, for answer i, juxtaposing reference content with answer content and a graphic indication of valid or invalid in the answer report 138, such as shown in FIG. 4 by way of example. Control proceeds (at block 622) back to block 608 if there are further answers in the answer response 110 to validate. The updated answer report 138 is returned (at block 624) to the client machine 100 to render to the user.

With the embodiment of FIG. 6, each answer in the answer response is validated against a reference having search terms based on keywords of the answer to determine whether the answer is sufficiently similar to validate as accurate. If a reference cannot be located that is sufficiently similar to the answer, then the answer cannot be validated and trusted, and indication of the lack of validation is returned to the user to inform the user not to rely on that answer because there is no supporting reference for the answer.

As discussed, the similarity analyzer 130 may use comparison techniques, such as comparing vectors formed of the answer content and reference content and other similar techniques for comparing similarity of passages of text. FIG. 7 provides one technique to determine similarity between an answer i in the answer response 110 and a reference 128 located for answer i. Upon initiating (at block 700) calculation of similarity score for answer/reference pair, the similarity analyzer 130 determines (at block 702) a domain of the question 102. A determination is then made (at block 704) of word types and weights of the word types associated with the determined domain. Specified word types to search upon may comprise noun, subject, object, adverb, etc. The weights assigned to the word types may add up to one and be indicated in the user service profile 146.

At blocks 706 through 718 a loop of operations is performed for each specified word type i of the determined word types. The words in the answer of word type i are determined (at block 708). A determination is then made (at block 710) of matching/similar words in the reference 128 for the determined words to map words of word type i in the answer i to words in the located reference 128. The similarity analyzer 130 calculates (at block 712) a similarity score 132 for each determined word in answer i and determined matching/similar word in reference 128. An average of the similarity scores of word type i is calculated (at block 714) and the determined weight for word type i is multiplied (at block 716) times the determined average to calculate a weighted average similarity score for data type i. Control proceeds (at block 718) back to block 706 to calculate the weighted average similarity score of the next data type. After calculating similarity scores 132 for all the answer/reference pairs, the weighted average similarity scores for all data types are added (at block 720) to calculate the aggregated similarity score of the answer i.

With the embodiment of operations of FIG. 7, the similarity score is calculated by determining similarity scores for different word types and then weighting the results to calculate an aggregated similarity score for an answer, which may be used to validate the answer for which it was calculated.

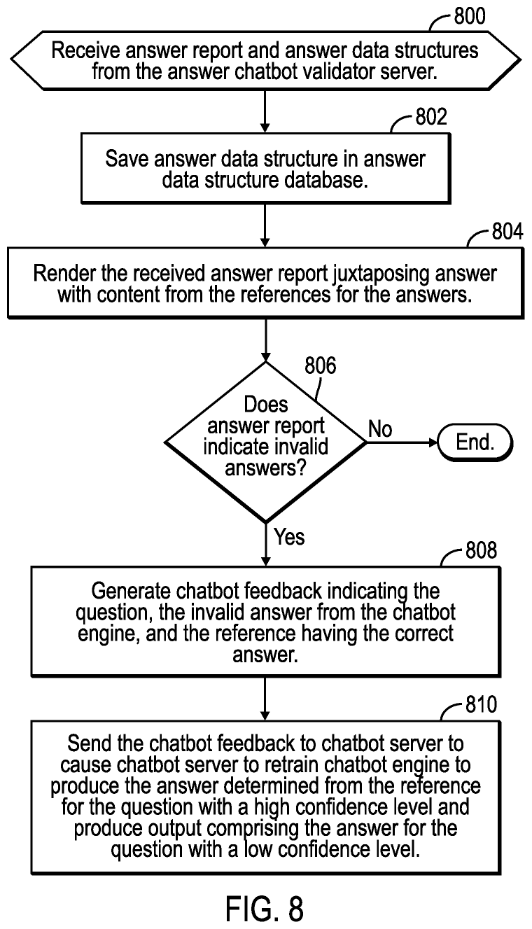

FIG. 8 illustrates an embodiment of operations performed by the client system 100, such as the chatbot monitor 112 and chatbot interface 104, to process the answer report 138 from the chatbot validator server 114 and determine actions to take based on whether the chatbot answers in the answer report 138 are invalid or valid. Upon receiving (at block 800) an answer report 138 and the answer data structures 200ᵢ for the answers in the answer response 110 from the chatbot validator server 114. The answer data structures 200ᵢ are saved (at block 802) in the answer database 144. The renderer 142 renders (at block 804) the received answer report 138 juxtaposing the answer(s) from the chatbot server 106 with content from the references 128 for the answers, including graphical correspondence between the answers and the relevant references, and a graphical validation of invalid or valid, such as shown in FIG. 4. If (at block 806) the answer report 138 indicates only valid or real answers, then control ends. If (at block 806) the answer report 138 indicates invalid answers, then the chatbot monitor 112 generates (at block 808) chatbot feedback 140 indicating the question, the invalid answer from the chatbot engine 108, and the reference having the correct answer. The chatbot feedback 140 is sent (at block 810) to the chatbot server 106 to cause the chatbot server 106 to retrain the chatbot engine 108 to produce the answer determined from the reference for the question with a high confidence level and produce output comprising the invalid answer for the question with a low confidence level.

With the embodiment of FIG. 8, the client computer 100 processes an answer report 138 from the chatbot validator server 114 to render the content of the answer report 138 in a computer display for the user. Further, if the answer report 138 indicates invalid answers, the client computer 100 may inform the chatbot server 106 to cause the chatbot server 106 to retrain the chatbot engine 108 to reduce the likelihood of producing the invalid or wrong answer for the question to help optimize the chatbot engine 108.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

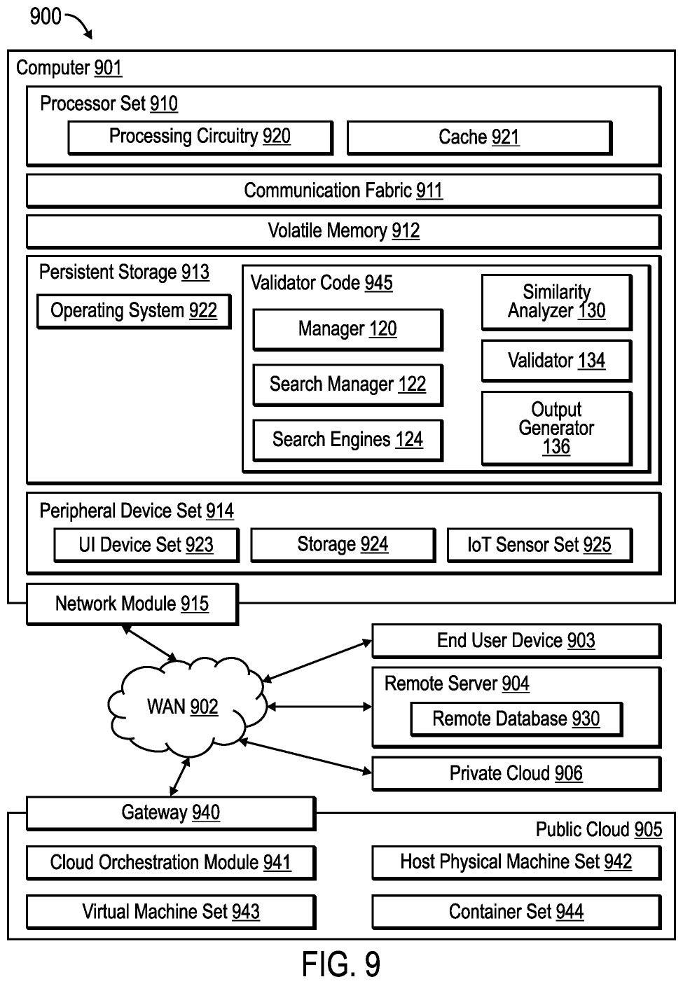

With respect to FIG. 9, computing environment 900 contains an example of an environment for the execution of at least some of the computer code involved in performing the inventive methods to validate answers from an artificial intelligence chatbot by searching for references that have high similarity scores with the answers as implemented in validator code 945, which may include the manager 120, search manager 122, search engines 124, similarity analyzer 130, validator 134, and output generator 136 described with respect to FIG. 1. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on. The EUD 903 may include the components of the client computer 100 described with respect to FIG. 1, including the chatbot interface 104, chatbot monitor 112, and renderer 142.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904. The remote server 904 may comprise the chatbot server 106 including a chatbot engine 108.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The letter designators, such as i and j are used herein to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for verifying answers produced from an artificial intelligence chatbot in response to questions inputted to the artificial intelligence chatbot, wherein the computer program product comprises a computer readable storage medium having computer readable program instructions that when executed perform operations, the operations comprising:
receiving an answer to a question submitted to the artificial intelligence chatbot;
searching a database using keywords from the answer to obtain a reference for the answer;
calculating a similarity score between the answer and the reference;
determining whether the similarity score exceeds a threshold value;
indicating, in answer information, that the answer is valid in response to the similarity score exceeding the threshold value or that the answer is invalid in response to the similarity score not exceeding the threshold value; and
generating an answer report indicating whether the answer is valid or invalid to transmit to a user a user that submitted the question to render.

2. The computer program product of claim 1, wherein the calculating the similarity score between the answer and the reference comprises:
determining word type similarity scores between words in the answer, of at least one specified word type, to words in the reference; and
aggregating the word type similarity scores to produce the similarity score between the answer and the reference.

3. The computer program product of claim 2, wherein the operations further comprise:
determining a domain of the question; and
determining specified word types for the domain, wherein the at least one specified word type comprises the determined specified word types for the domain.

4. The computer program product of claim 2, wherein the specified word type is part of plurality of specified word types, wherein there is a weight for each of the specified word types, wherein the calculating the word type similarity scores comprises:
for each word type of the word types, calculating a weighted average similarity score as an average of the similarity scores for the word type multiplied by a weight for the word type; and
summing weighted average similarity scores for the word types to produce the similarity score between the answer and the reference.

5. The computer program product of claim 1, wherein the receiving the answer comprises receiving a plurality of answers to the question, wherein the operations of searching the database, determining the similarity score, and determining whether the similarity score exceeds the threshold value are performed for the answers, wherein the answer report renders information indicating whether the answers are valid or invalid.

6. The computer program product of claim 1, wherein the operations further comprise:
updating the answer information to indicate the reference and information to locate the reference; and
providing the answer information to use to train the artificial intelligence chatbot to produce an invalid answer with a low confidence level.

7. The computer program product of claim 1, wherein the answer report juxtaposes the answer with respect to content of the reference and visual indication of whether the answer is valid or invalid.

8. The computer program product of claim 1, wherein the searching the database comprises:
determining a domain of the question and the answer; and
determining a domain database applicable to the domain of the question and the answer, wherein the domain database is searched to the obtain reference.

9. A system for verifying answers produced from an artificial intelligence chatbot in response to questions inputted to the artificial intelligence chatbot, further comprising:
a processor; and
a computer readable storage medium having computer readable program instructions that when executed by the processor performs operations, the operations comprising:
receiving an answer to a question submitted to the artificial intelligence chatbot;
searching a database using keywords from the answer to obtain a reference for the answer;
calculating a similarity score between the answer and the reference;
determining whether the similarity score exceeds a threshold value;
indicating, in answer information, that the answer is valid in response to the similarity score exceeding the threshold value or that the answer is invalid in response to the similarity score not exceeding the threshold value; and
generating an answer report indicating whether the answer is valid or invalid to transmit to a user a user that submitted the question to render.

10. The system of claim 9, wherein the calculating the similarity score between the answer and the reference comprises:
determining word type similarity scores between words in the answer, of at least one specified word type, to words in the reference; and
aggregating the word type similarity scores to produce the similarity score between the answer and the reference.

11. The system of claim 10, wherein the operations further comprise:
determining a domain of the question; and
determining specified word types for the domain, wherein the at least one specified word type comprises the determined specified word types for the domain.

12. The system of claim 9, wherein the receiving the answer comprises receiving a plurality of answers to the question, wherein the operations of searching the database, determining the similarity score, and determining whether the similarity score exceeds the threshold value are performed for the answers, wherein the answer report renders information indicating whether the answers are valid or invalid.

13. The system of claim 9, wherein the operations further comprise:
updating the answer information to indicate the reference and information to locate the reference; and
providing the answer information to use to train the artificial intelligence chatbot to produce an invalid answer with a low confidence level.

14. The system of claim 9, wherein the searching the database comprises:
determining a domain of the question and the answer; and
determining a domain database applicable to the domain of the question and the answer, wherein the domain database is searched to obtain the reference.

15. A method for verifying answers produced from an artificial intelligence chatbot in response to questions inputted to the artificial intelligence chatbot, further comprising:
receiving an answer to a question submitted to the artificial intelligence chatbot;
searching a database using keywords from the answer to obtain a reference for the answer;
calculating a similarity score between the answer and the reference;
determining whether the similarity score exceeds a threshold value;
indicating, in answer information, that the answer is valid in response to the similarity score exceeding the threshold value or that the answer is invalid in response to the similarity score not exceeding the threshold value; and
generating an answer report indicating whether the answer is valid or invalid to transmit to a user a user that submitted the question to render.

16. The method of claim 15, wherein the calculating the similarity score between the answer and the reference comprises:
determining word type similarity scores between words in the answer, of at least one specified word type, to words in the reference; and
aggregating the word type similarity scores to produce the similarity score between the answer and the reference.

17. The method of claim 16, wherein the operations further comprise:
determining a domain of the question; and
determining specified word types for the domain, wherein the at least one specified word type comprises the determined specified word types for the domain.

18. The method of claim 15, wherein the receiving the answer comprises receiving a plurality of answers to the question, wherein the operations of searching the database, determining the similarity score, and determining whether the similarity score exceeds the threshold value are performed for the answers, wherein the answer report renders information indicating whether the answers are valid or invalid.

19. The method of claim 15, wherein the operations further comprise:
updating the answer information to indicate the reference and information to locate the reference; and
providing the answer information to use to train the artificial intelligence chatbot to produce an invalid answer with a low confidence level.

20. The method of claim 15, wherein the searching the database comprises:
determining a domain of the question and the answer; and
determining a domain database applicable to the domain of the question and the answer, wherein the domain database is searched to obtain the reference.
